(19) United States
(12) Patent Application Publication
(10) Pub. No.: US 2017/0239630 A1
(43) Pub. Date: Aug. 24, 2017

(54) Compact Water Agitator for Pest Control

(71) Applicant: Ananya Ashish Joshi, Matawan, NJ (US)

(72) Inventor: Ananya Ashish Joshi, Matawan, NJ (US)

(21) Appl. No.: 15/418,724

(22) Filed: Jan. 28, 2017

Related U.S. Application Data
(60) Provisional application No. 62/298,962, filed on Feb. 23, 2016.

(51) Int. Cl. B01F 13/00; B63H 21/12; A01M 99/00; B01F 15/00; C02F 1/34

(52) U.S. Cl. CPC B01F 13/0049; B01F 15/00558; C02F 1/34; A01M 99/00; B63H 21/12; A01M 2200/012; B01F 2215/0052; C02F 2201/009; C02F 2203/008; B63H 2021/171

(57) ABSTRACT

Mosquitoes are vectors for many dangerous diseases such as Malaria, Dengue, Yellow Fever, West Nile, and those from Zika virus etc. Mosquito transmitted diseases occur mostly in tropical, developing countries and create public health crises due to lack of adequate resources and rapid transmission. Malaria took 429,000 lives in 2015 and the impending Zika crisis shows the need for effective mosquito control. Nearly half of the world's population is at risk of malaria. Current mosquito control efforts focus on reducing the population of mosquitoes. The many mosquito control strategies such as using tarps to suffocate larvae, insecticides, genetic engineering, biocontrol using fish etc. have substantial drawbacks. These methods are environmentally hazardous, expensive, inefficient, hard to maintain, bulky, or energy intensive. Mosquitoes breed in stagnant water. They cannot breed in agitated water or running water. Thus, this patent describes water agitators that are environmentally safe, efficient, and cost-effective. In this patent, three water agitators prototypes are presented. They are self-sustaining, lightweight, mobile, and have minimal potential for misuse. The agitators consume solar energy. They are self propelling and do not require maintenance, such as changing parts. They are designed to be inexpensive, reusable, and mass-producible. These agitators can cover a much larger area of water compared to their size. They target small to large water areas. Agitators are versatile and can be used in flower vases, open rain jars, tire tracks, mining pits, small ponds etc.

### CROSS REFERENCE TO RELATED APPLICATION

This application claims benefit of U.S. Provisional Application Nos. 62/298962, filed, Feb. 2, 2016, which is hereby incorporated in its entirety by reference.

### BACKGROUND OF THE INVENTION

Globally, millions of people die each year due to mosquito transmitted diseases. The main purpose of this invention is to provide a cost-effective, safer, and sustainable alternative for mosquito control. The proposed designs are solar powered, safe, cost-effective, and create minimal sound pollution. They do not use chemical processes. They do not require frequent maintenance and use lasting plastic and metal materials.

Mosquitoes breed in a variety of water bodies, such as freshwater/saltwater lakes and ponds, and in a variety of areas, such as small flower vases and large water tanks. The mosquito breeding cycle can be interrupted by agitating water so it is no longer stagnant.

Some existing large scale pond aerators create bubbles using chemical processes, such as decomposing hydrogen peroxide, or pushing compressed air through aerator stones. These aerators are large scale, expensive, and require a lot of energy (often provided by batteries). They are difficult to maintain. Other products are less effective or infeasible solutions to the current problem. One existing solar birdbath is the Allied Precision Water Wiggler. The system uses a “wiggling action” to prevent mosquito breeding in shallow birdbaths. This Water Wiggler is stationary, costly, and has limited use - only in birdbaths. There are also several types of direct mosquito control/prevention products, including insecticides. These are ineffective or hazardous (chemicals in insecticides are harmful). The only effective, safe solution for preventing mosquito breeding in stagnant water currently is to drain the water source. In many cases, draining the water source is not possible. There is a video on Youtube that describes a Solar Scare-Mosquito Device, which is bulky, needs large power, and cannot handle diverse mosquito breeding grounds, such as a vase or a water jug. It is also expensive for mass scale production. No current product has an emphasis on cost-effective prevention for mosquito breeding in diverse scenarios.

The prior art has taught that there are several methods for water agitation, including manually moving the water and using bubbles. It also shows that there are few solutions that adequately address mosquito control. Thus, there is a need for a solution to the abundant mosquito breeding grounds where conventional solutions to water agitation are not feasible and existing solutions to mosquito control are ineffective.

### BRIEF SUMMARY OF THE INVENTION

A portable, compact water agitators, which use simple mechanical processes of vibration, paddling, and bubbling motion to agitate water surfaces. Intended Use: Small, solar-powered water agitators are used to control the incidence of mosquito-transmitted diseases at low cost. The main application of these agitators is in tropical bodies of water, which have sunlight in abundance.

### BRIEF DESCRIPTION OF THE DRAWINGS

FIGS. 1-3 are circuit diagrams of the 3 agitators

FIG. 4-6 are pictures of the agitators prototypes

### DETAILED DESCRIPTION OF THE INVENTIONS

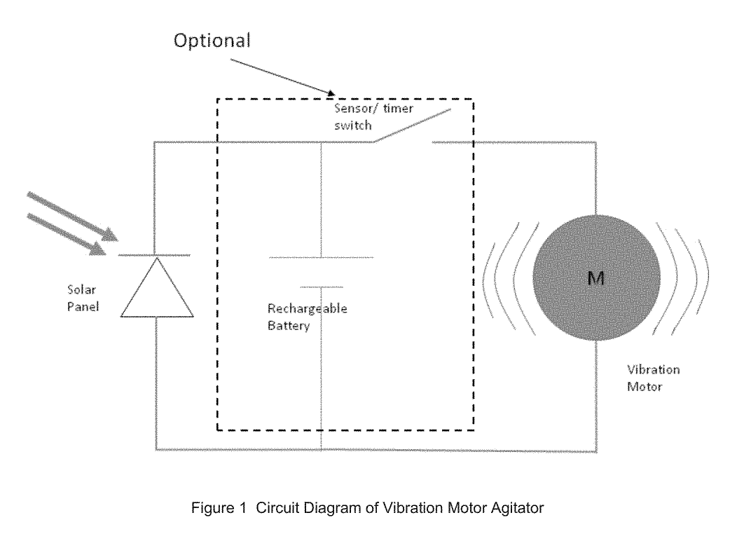

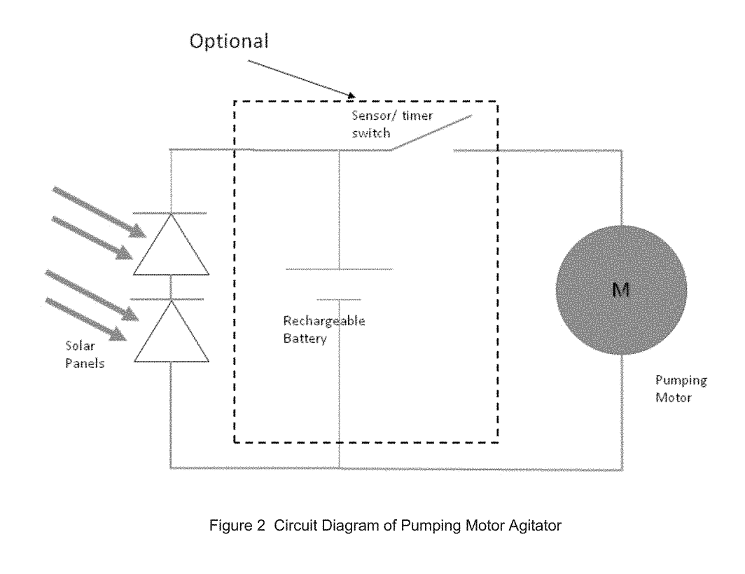

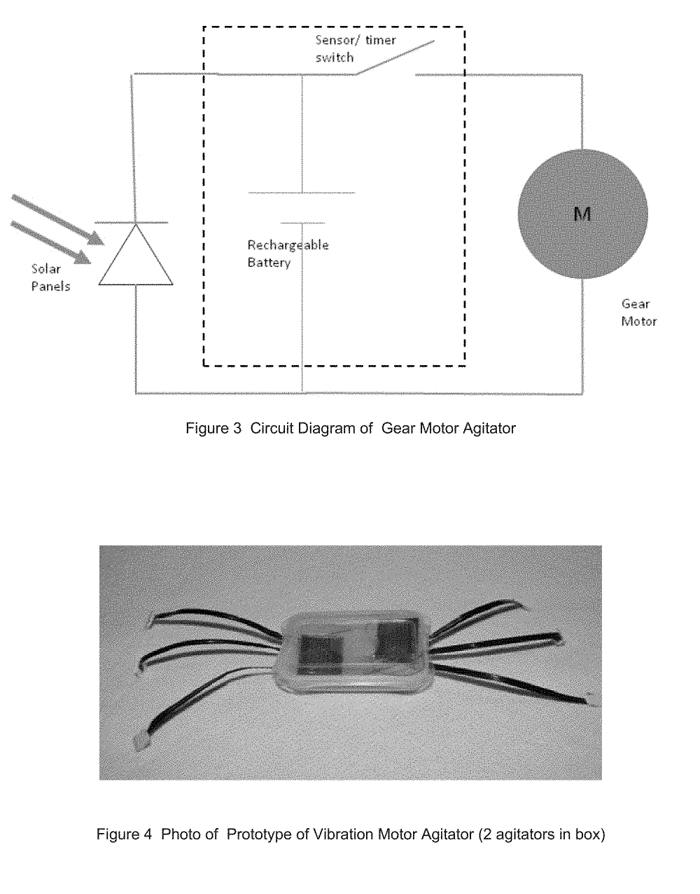

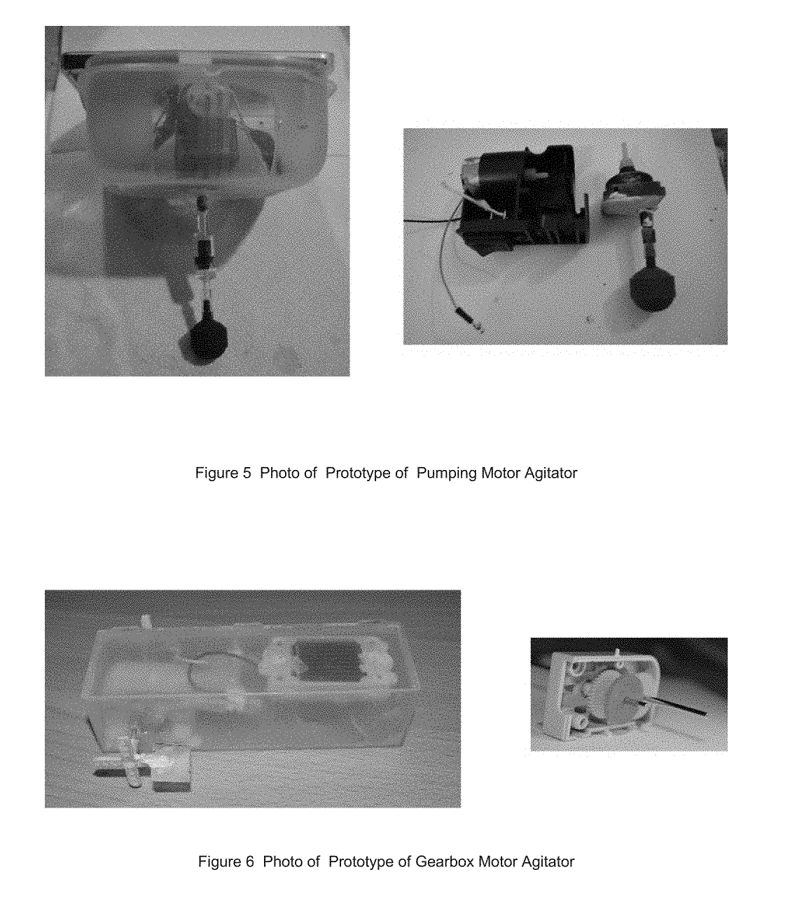

Three agitator prototypes for mosquito control are designed to cover small to large, freshwater and saltwater systems. Prototypes consume solar energy. In the first prototype, solar panels are soldered to small vibration motors (FIG. 1). The solar panels are attached inside a small, clear plastic box. Holes are drilled in the sides of the box and zip ties are wrapped around the motors. The box is then waterproofed. A wide piece of plastic is placed at the end of each zip tie to increase the water surface agitation. The vibration motors and zip ties create ripples on the water surface. In the second prototype, a crank is attached to a motor, which pushes a compressor up and down, pumping air into an aerator stone. This then creates fine bubbles in the water through the aerator stone (FIG. 2). The second prototype was built by soldering solar panels to a pumping motor that is used with an aerator stone. There is then a back valve to prevent water from coming back into the box. This assembly was placed in a plastic box with a hole drilled on the bottom to let out the bubbles. The box was then waterproofed. The final embodiment, or the third prototype, is a solar powered boat built for slow, steady water agitation in large water areas (FIG. 3). It uses gear system and operates using solar power. Two holes are drilled into a long, thin, clear plastic box, and paddles are attached to axles from the gearbox. Paddle are used to propel the box to cover large water area. Small, wide pieces of plastic are water welded to the end of the paddles to increase water surface agitation. The box is then waterproofed. All the plastic boxes are chosen so that the devices will float and are weighted to be centered (so they don't tilt). Additionally, backup batteries, timers, and sensors, such as dawn to dusk sensor, can be and are added to each prototype.

What is claimed is:

1. A portable, compact water agitator for use indoors and outdoors in all systems of water such as
a. Freshwater and saltwater water bodies
b. Water tanks
c. Water containers, such as bowls, tire tracks, vases etc.
d. Lakes and ponds
e. Traditional rain jars and open pools of water
using solar panels and/or backup batteries

2. Portable and compact surface water agitator using vibration techniques .

3. Portable and compact surface water agitator using paddling motion

4. Portable and compact surface water agitator using bubbles from a pump

5. Compact water agitator targeting mosquito populations

6. Compact water agitator with solar panels and/or backup batteries.

7. Compact water agitator with timers.

8. Compact water agitator with sensors, such as dawn to dusk sensors.

9. Water agitators containing solar panels, clear plastic casing, vibration motors, and external appendages to agitate surface.

10. Water agitators containing solar panels, clear plastic casing, motor and gearbox with external appendages to agitate surface.

11. Water agitators containing solar panels, clear plastic casing, pumping motor with aerator stone and back valve to agitate surface.

12. Water agitators with an additional chemical dispenser element to:
a. purify water.
b. Supplement mosquito control

13. Water agitators with remote control

14. Water agitator that target mosquito breeding

15. Portable water agitators targeted at pest and water control including
a. Mosquitoes
b. Flies
c. Bacteria
